(19) United States
(12) Patent Application Publication
(10) Pub. No.: US 2021/0328203 A1
(43) Pub. Date: Oct. 21, 2021

(54) ELECTROCHEMICAL CELLS AND METHODS OF USING AND MAKING THE SAME

(71) Applicant: EaglePicher Technologies, LLC, St. Louis, MO (US)

(72) Inventors: Dong Zhang, Webb City, MO (US); Jason A. Mudge, Joplin, MO (US); David Timothy Andrew Darch, Neosho, MO (US); Mario Destephen, Joplin, MO (US); Ernest Ndzebet, Carl Junction, MO (US)

(73) Assignee: EaglePicher Technologies, LLC, St. Louis, MO (US)

(21) Appl. No.: 16/853,148

(22) Filed: Apr. 20, 2020

(51) Int. Cl. H01M 2/10; H01M 2/26

(52) U.S. Cl. CPC H01M 2/1016; H01M 2/26

(57) ABSTRACT

The disclosure provides an electrochemical cell that may comprise a housing; a cathode connection, in the housing, that is associated with a cathode; an anode connection, in the housing, that is associated with an anode; an electrolyte; and a header assembly. The header assembly can include a cathode connection assembly; an anode connection assembly; and a stepped header body that includes (a) a first step portion having a first thickness and first step surface, (b) a second step portion having a second thickness and a second step surface, and the first thickness being thicker than the second thickness. The disclosure may also provide systems and methods of making such a cell.

### BACKGROUND

The disclosed subject matter relates to an electrochemical cell of a battery, and methods of use and manufacture thereof. More particularly, the disclosed subject matter relates to an electrochemical cell that includes a header assembly.

The technical field of the disclosure is electrochemical cells. An electrochemical cell can include a housing that houses internal components of the cell. The internal components of the cell can include an anode, a cathode, electrolyte, and other components of the cell. The anode can interact with the cathode so as to generate electrical power. The anode can be connected to an anode connection. The cathode can be connected to a cathode connection. The anode connection and the cathode connection can be respectively connected to external connections so as to provide electrical power to a device. The electrochemical cell can include a header or header assembly that seals the electrolyte and other components of the battery.

However, there are various problems associated with the above described and other known technology.

### SUMMARY

The disclosure provides an electrochemical cell that may comprise a housing; a cathode connection, in the housing, that is associated with a cathode; an anode connection, in the housing, that is associated with an anode; an electrolyte; and a header assembly. The header assembly can include a cathode connection assembly; an anode connection assembly; and a stepped header body that includes (a) a first step portion having a first thickness and first step surface, (b) a second step portion having a second thickness and a second step surface, and the first thickness being thicker than the second thickness. The disclosure may also provide systems and methods of making such a cell.

Various further aspects and features of the disclosure are described below.

### BRIEF DESCRIPTION OF THE DRAWINGS

The disclosed subject matter of the present disclosure will now be described in more detail with reference to exemplary embodiments of the apparatus and method, given by way of example, and with reference to the accompanying drawings, in which:

FIG. 1 is a diagram showing an electrochemical cell with detail of a header assembly, in accordance with one or more embodiments.

FIG. 2 shows an exploded view of an electrochemical cell the same as or similar to the cell 10 of FIG. 1, in accordance with one or more embodiments.

FIG. 3 is a cross-section view, along line 3-3 of FIG. 1, of an electrochemical cell the same as or similar to the cell of FIG. 1, in accordance with one or more embodiments.

FIG. 4 is a perspective view of an illustrative anode current collector to which can be attached to lithium coupons (or anodes), in accordance with one or more embodiments.

FIG. 5 is an example of an anode current collector (in a flat form), in accordance with one or more embodiments.

FIG. 6 is a perspective view of the anode current collector and two lithium coupons (i.e. anodes), in accordance with one or more embodiments.

FIG. 7 is a perspective view of a header assembly of a battery showing details of the cell of FIG. 2, in accordance with one or more embodiments.

FIG. 8 is a cross-section view, along line 8-8 of FIG. 7, of a header assembly the same as or similar to the header assembly of FIG. 1, in accordance with one or more embodiments.

FIG. 9 is a top view of a header assembly in accordance with one or more embodiments.

FIG. 10 is a bottom perspective view of a header assembly of FIG. 1, in accordance with one or more embodiments of the disclosure.

FIG. 11 is a top perspective view of a header assembly of FIG. 1, in accordance with one or more embodiments of the disclosure

### DETAILED DESCRIPTION OF EXEMPLARY EMBODIMENTS

A few inventive aspects of the disclosed embodiments are explained in detail below with reference to the various drawing figures. Exemplary embodiments are described to illustrate the disclosed subject matter, not to limit its scope, which is defined by the claims. Those of ordinary skill in the art will recognize a number of equivalent variations of the various features provided in the description that follows.

The present disclosure relates generally to the technical field of batteries such as batteries for implantable medical devices. More particularly, for example, the present disclosure relates to a cell for use in an implantable cardiac monitor (ICM) device or other implantable medical products.

As described herein, there are various problems with known technology relating to electrochemical cells, i.e. cells. An electrochemical cell can include a housing with housing walls. The housing walls can provide an interior volume to the electrochemical cell. The interior volume of the electrochemical cell can house various components of the electrochemical cell. The housing walls can include or define an opening. The opening can allow access to the interior volume of the cell. It is known in the art to provide a header or header assembly to close off or cap off the opening of the cell so as to enclose the interior volume of the cell. The header assembly itself can also include various components or parts. Known headers are commonly constructed with a flat interior surface. However, with such construct, known headers are deficient. Known headers fail to be constructed in a manner to enhance size of an interior volume of the cell and to minimize external size of the cell in conjunction with providing structure needed to accommodate various components in the header assembly.

Accordingly, an electrochemical cell is disclosed that addresses the above shortcomings. The electrochemical cell of the disclosure can include a stepped header or header assembly. The stepped header can include multiple step portions, i.e. stepped portions, having different thickness. The enhanced step design of the disclosed header can allow for enhanced or maximized internal cell volume. A first “step” of the cell can be designed and constructed around seal requirements, and specifically around glass-to-metal seal requirements. A second “step” of the cell can be designed and constructed around ball seal requirements. The electrochemical cell of the disclosure can, as a result, provide increased internal volume, the utilization of which allows the cell to attain electrolyte volume goals and void volume goals. Accordingly, the electrochemical cell of the disclosure can provide a high-energy-density electrochemical cell.

The present disclosure pertains to an electrochemical cell that converts chemical energy to electrical energy. A battery, in accordance with one or more embodiments, may include one or more electrochemical cells of the disclosure, which may be electrically connected or wired to each other, and to respective exterior connections. Specifically, the disclosure pertains to an electrochemical cell illustratively having a cathode, electrolyte, a separator and a lithium anode on a current collector. The disclosure provides an implantable electrochemical cell having high specific energy. The cell is useful in implantable cardiac monitor (ICM) devices, other implantable medical products, and other devices, for example.

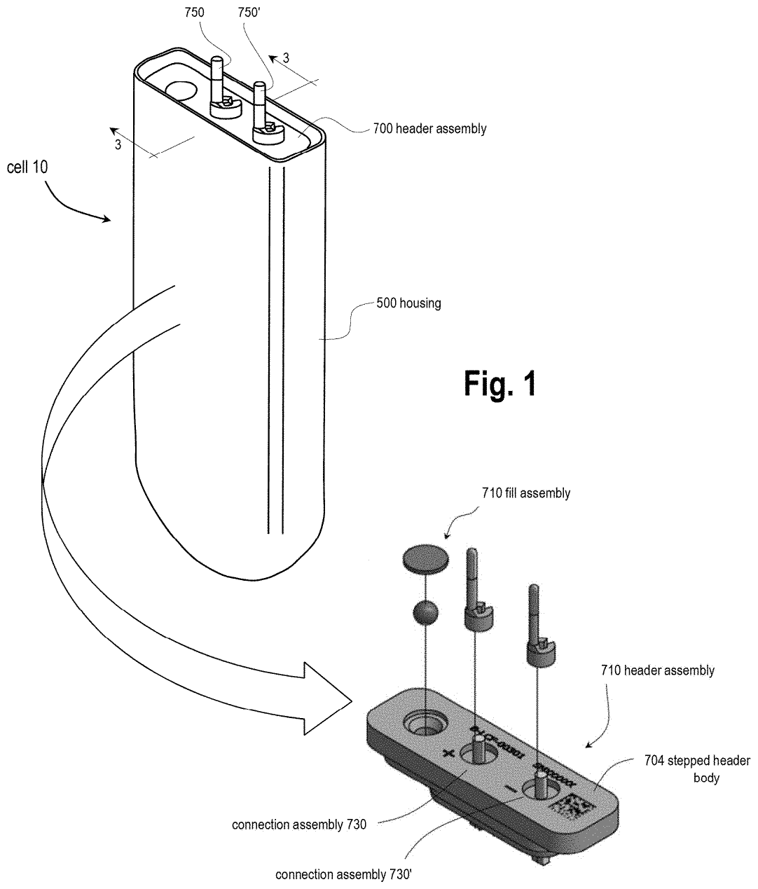

FIG. 1 is a diagram showing an electrochemical cell 10 with detail of an anode current collector 100, in accordance with one or more embodiments. The cell 10 includes a housing or case 500 and a header assembly 700. The housing 500 in conjunction with the header assembly 700 contains various components as described in detail below. In particular, the cell 10 includes a header assembly having a stepped construct, as described in detail below.

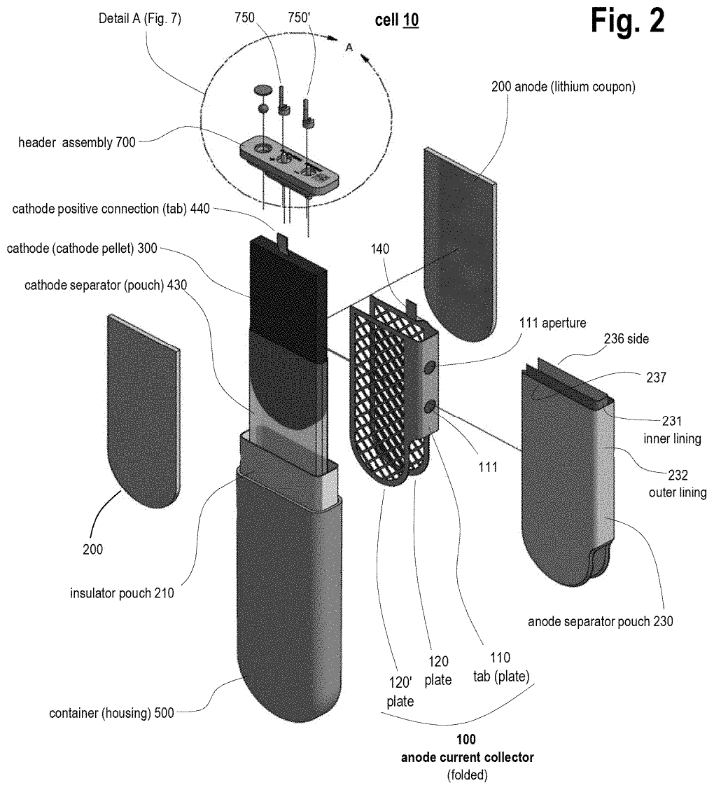

FIG. 2 shows an exploded view of an electrochemical cell 10 the same as or similar to the cell 10 of FIG. 1, in accordance with one or more embodiments.

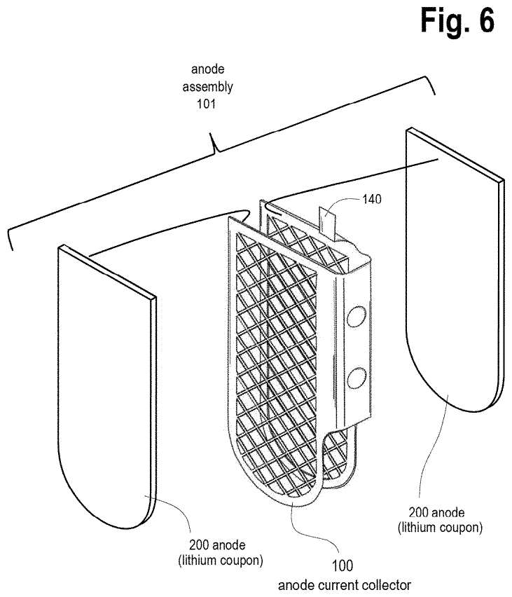

As shown in FIG. 2, the cell 10 includes at least one anode 200 (as shown two anodes 200) and an anode current collector 100. Illustratively, the anode 200 may comprise one, two or more metallic lithium coupons 200, pressed onto the current collector 100. The (a) anodes 200, which may be constituted by lithium coupons, and (b) anode current collector 100 can collectively be characterized as an anode/anode current collector assembly 101 or lithium coupon/anode current collector assembly 101, or simply characterized as an anode assembly 101 as shown in FIG. 6, for example, and further described below.

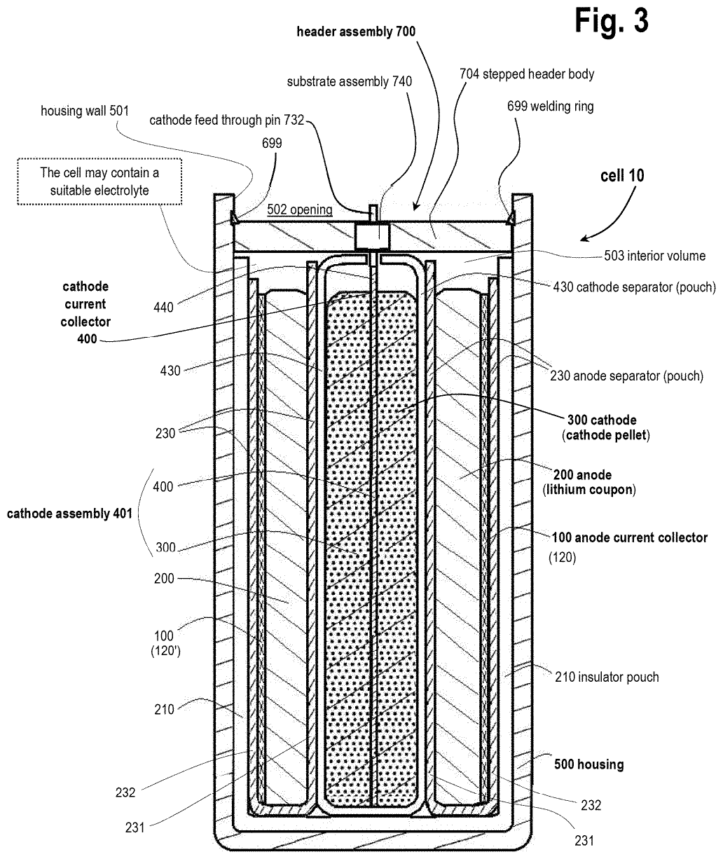

Relatedly, the cathode current collector 400 and the one or more cathode/cathode pellets 300 can be characterized as a cathode assembly 401, as shown in FIG. 3.

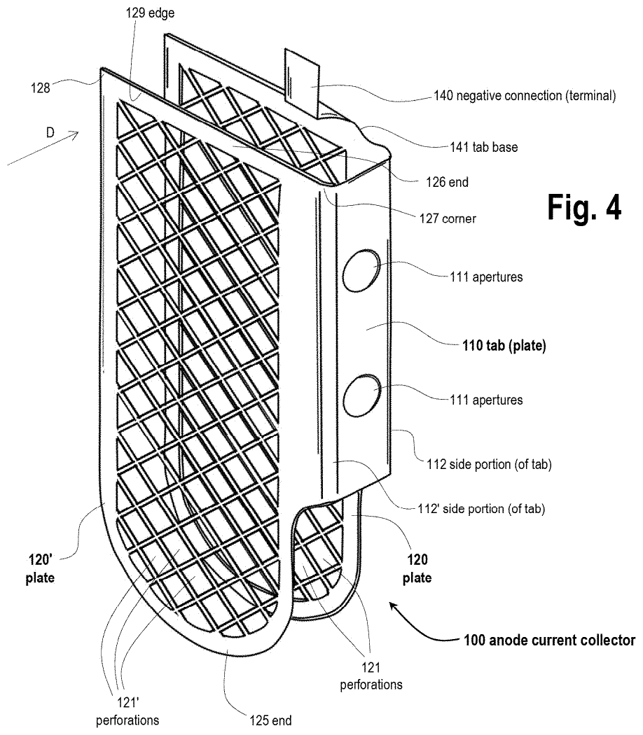

The anode current collector 100 may be constructed of material such as stainless steel or copper, for example. The anode current collector 100, as also shown in FIG. 4, can be perforated 121 in accordance with one or more embodiments. However, such construct including perforations is for purposes of illustration and an electrochemical cell of the disclosure can include other constructs and other types of anode current collectors.

In accordance with illustrative embodiments of the invention, the perforations 121 may be diamond shape, circular shape, rectangular shape, square shape and/or other shapes. The ratio of perforated area to the total area of the collector (excluding the central folding and tabbing area) may be about 0.6, for example, in accordance with one or more embodiments, and as otherwise described herein. The thickness of the current collector 100 may be about 0.050 mm. An alignment feature 110, 111 may be provided in the center of the current collector 100 that facilitates proper anode to current collector alignment and proper anode current collector folding. The electrochemical cell of FIG. 2 can include two lithium coupons, i.e. anodes, 200 and one folded anode current collector 100. The perforations 121 in a particular anode current collector 100 may be of different shape, such as some perforations having a diamond shape and some perforations having a rectangular shape, for example. Such electrodes, i.e. the lithium coupons 200, may be advantageously used as the anode of a primary lithium electrochemical cell, for example of various cathode types.

FIG. 2 and FIG. 3 show further detail of the interrelationship of various components of the electrochemical cell or cell 10. As described above, the cell 10 can include the housing 500 and the header assembly 700. The housing 500 in conjunction with the header assembly 700 can contain various components of the cell including electrolyte of the cell.

An insulator pouch 210 may be provided inside the housing 500 so as to provide a lining to the housing 500. As shown in FIG. 3, for example, inside the insulator pouch 210 can be provided an anode separator 230. The anode separator 230 may be in the form of a folded pouch, as also shown in FIG. 2, so as to form two sides 236, 237. Accordingly, the anode separator pouch 230 may be in a folded arrangement as shown in FIG. 2. The anode separator pouch 230 may include an inner lining 231 and an outer lining 232. Inside each side of the anode separator pouch 230 may be positioned both anode 200 and plates 120, 120′ of anode current collector 100, in accordance with one or more embodiments. The anode 200 may be in the form of a lithium coupon 200. The lithium coupons 200 can be respectively positioned on the anode current collector plates 120, 120′, so as to form the anode assembly 101. As shown in FIG. 3, the lithium coupons 200 are positioned on an interior side of the respective collector plate 120, 120′ to which each is attached. The lithium coupon/anode current collector assembly 101, i.e. the anode assembly 101, can be enclosed in the anode separator pouch 230 with open or closed top. With regard to the anode separator pouch 230, the inner lining 231 height can be greater than the outer lining 232 height, to provide good isolation between a cathode assembly 401 and anode assembly 101. In accordance with one or more embodiments of the disclosure, the anode current collector 100 and anodes 200 can be slid into the anode separator pouch 230 from above the anode separator pouch 230, i.e. slid into the top of the anode separator pouch 230. In particular, (1) one side of the anode assembly 101 (plate 120, anode 200) can be slid into one side of the anode separator pouch 230 between the outer lining 232 and the inner lining 231, in conjunction with (2) the other side of the anode assembly 101 (plate 120′, anode 200) can be slid into the other side of the anode separator pouch 230 between the outer lining 232 and the inner lining 231. As a result, the arrangement illustrated in FIG. 3 can be provided.

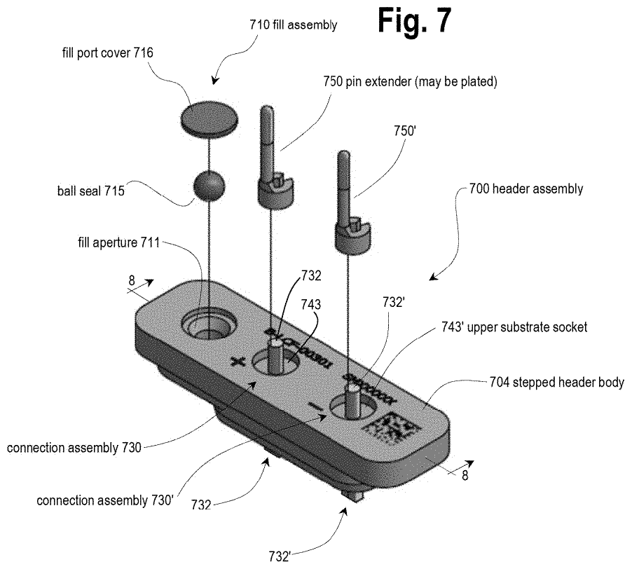

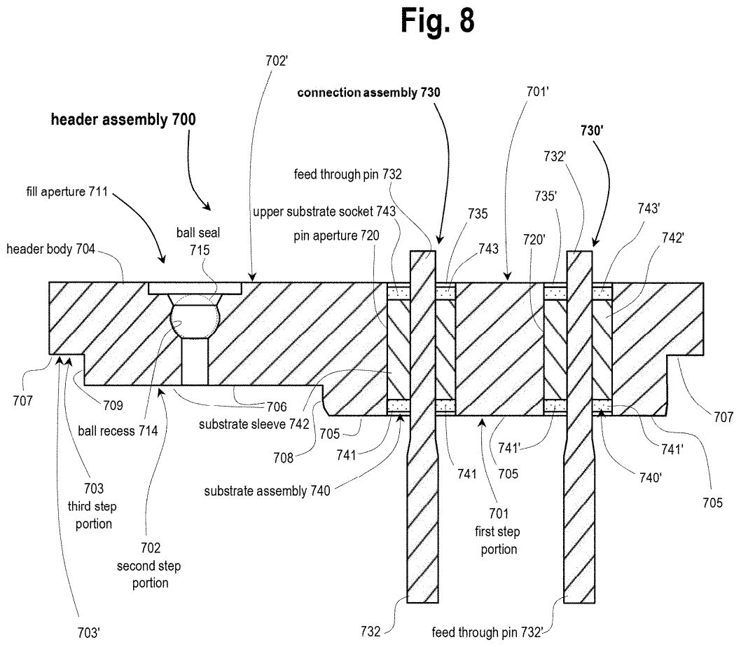

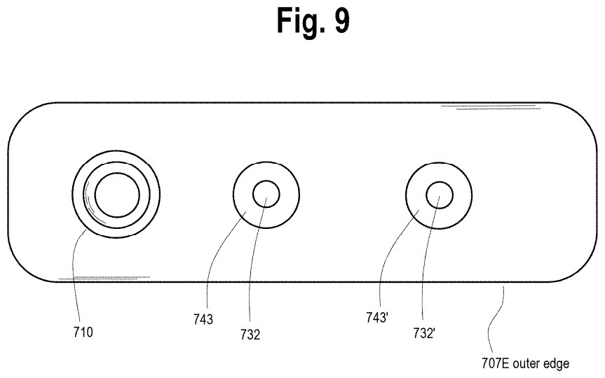

As shown in FIG. 2 and FIG. 3, the housing 500 also includes a cathode separator 430, which may be in the form of a cathode separator pouch 430. The cathode separator pouch 430 may be provided between the two sides 236, 237 of the anode separator pouch 230, as such is folded. Provided within the cathode separator pouch 430 is one or more cathodes 300 and a cathode current collector 400. Each cathode 300 may be constituted by a cathode pellet 300. Illustrative shape of the cathode 300 are shown in FIG. 2 and FIG. 3. The cathode current collector 400 may be provided in the form of a plate that is provided between the two cathodes 300. The cathode current collector 400, i.e. plate for example, may be constituted and/or include a body that extends throughout a substantial extent of the width and height of the cathode(s) 300. A cathode connection 440 or cathode positive connection 440 may be integrally formed with the cathode current collector 400 and extend above the cathodes 300 as is shown in FIG. 2 and FIG. 3. The cathode positive connection 440 may engage with a corresponding connection, i.e. cathode connection assembly 730, in stepped header body 704. For example, the cathode positive connection 440 may engage with, as shown in FIG. 3, cathode feedthrough pin 732. Relatedly, the negative connection or tab 140 of the anode assembly 101 may engage with a corresponding connection in stepped header body 704. Further details are described below with reference to FIGS. 7 and 8, for example.

In accord with at least some embodiments of the disclosure, a header assembly 700 is shown in FIG. 2 and FIG. 3 and is shown in further detail in FIG. 7. The header assembly 700 can include a stepped header body 704. The stepped header body 704 may be shaped so as to conform and mate with an inner periphery of the housing 500. For example, one or more welding rings 699 (FIG. 3) or other connection structure may be utilized to attach the header assembly 700 to the housing 500 at a desired position.

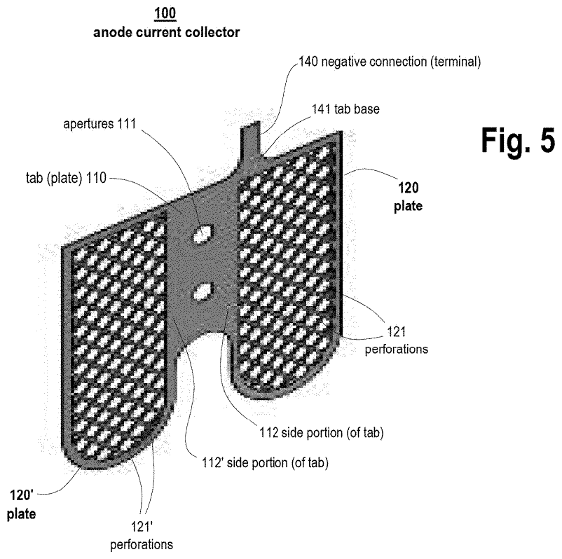

FIG. 4 shows anode current collector 100 in a folded state. According to one or more embodiments, as described above, two metallic lithium coupons 200 are used as the anode of the electrochemical cell, as shown in FIGS. 2, 3 and 6, for example. The lithium coupons 200 may be respectively fixed or positioned adjacent to the anode current collector 100. FIG. 5 represents a flat view of a metallic current collector 100, in accordance with one or more embodiments. That is, FIG. 5 shows an anode current collector 100 in a flattened or unfolded state. As shown in FIG. 4 and FIG. 5, the anode current collector 100 includes a first plate 120, a second plate 120′, and a tab or bridge plate 110 that serves to connect the plates 120, 120′. The current collector 100 can include perforations. More specifically, the plates 120, 120′ may be provided with perforations 121, 121′. The plates 120, 120′ may be flat or substantially flat as shown in FIG. 4, i.e. in an operational configuration as shown in FIG. 4. Alternatively, the plates 120, 120′ may be some other shape (and not flat), such as curved in a direction along tab 110 and/or curved in a direction perpendicular to a length of the tab 110, for example.

From the perspective along direction D in FIG. 4, the plate 120 may be the same shape as the plate 120′. For example, the plate 120 may include a first end 125 and a second end 126, with the first end being rounded and the second end defined by two corners 127, 128 and linear edge or straight edge 129 extending between such two corners 127, 128. In general, as otherwise described herein, the plate 120 may be mirror image of, and have the same structure as, the plate 120′.

As shown in FIG. 5 and FIG. 4, the current collector 100 also may be provided with alignment features including solid tab or plate 110 in the center of the anode current collector 100. The solid tab or plate 110 may be characterized as a bridge plate in that tab 110 bridges between the plate 120′ and the plate 120. The tab 110 may be provided with a plurality of apertures 111. The lithium coupons 200 can be positioned on the anode current collector plates 120, 120′ (for example, on an interior side of the anode current collector plates 120, 120′), and the anode current collector 100 can be folded to the shape of design. The one or more apertures 111 can serve as an alignment feature during anode assembling process or assembling process of the cell 10. The apertures 111 can help the anode current collector 100 be positioned on a fixture or assembly, and can assist to allow consistent and accurate placement of one or more lithium coupons 200 at or on the correct position on the anode current collector 100, i.e. on the plates 120, 120′. In addition, the apertures 111 can help fold the current collector correctly. As shown in FIG. 5, the tab 110 can include a side portion 112. The plate 120 can be attached along the side portion 112. The tab 110 can also include a side portion 112′. The plate 120′ can be attached along the side portion 112′.

Accordingly, the tab 110 can have a plurality of apertures 111 that include a first aperture and a second aperture, and the first aperture positioned over the second aperture in the tab. The first aperture and the second aperture can each be centered in the tab 110 between a first side portion 112 and the second side portion 112′, as shown in FIG. 4, for example.

As shown in FIG. 5, the anode current collector 100 may also be provided with a negative connection, terminal or tab 140, in accordance with one or more embodiments of the disclosure. The negative connection 140 may be a terminal, tab, or similar structure that extends from one of the plates 120, 120′ or may extend from the tab 110. The connection 140 may include a tab base 141 that is widened and/or may be of structure or shape as desired.

The proportion of perforation can be defined as the ratio of (a) surface area (or otherwise characterized as the lack of surface area) of the perforation void of material to (b) total surface area of the collector excluding the central folding and tab area, in accordance with one or more embodiments. With reference to FIG. 4, which shows the anode current collector 100 in a folded state, a tab area may be characterized as the area of the anode current collector 100 that is provided substantially in the same plane as the apertures 111, i.e. substantially co-planer to the apertures 111, and the turned corners or edges along each side portion 112, 112′ of the tab 110. The current collector 100 may allow uniform utilization of lithium coupons during discharge. At the same time, the perforated anode current collector 100 can occupy a minimal amount of volume inside the cell 10, allowing maximization of the amount of electrochemically active components in the cell 10 and—as a result—provide high energy density.

In accordance with one or more embodiments, the total surface area of the current collector excluding the central folding and tab area may be equal to or be a little smaller than the area of the lithium coupons. In accordance with one or more embodiments, the ratio of the surface area of the current collector (excluding the central folding and tab area) to the area of the lithium coupons may be between 70% to 100%, preferably may be between 80% and 100%, or preferably may be between 90% and 100%. Such ratio of the surface area of the current collector (excluding the central folding and tab area) to the area of a lithium coupon may relate to one side (i.e. plate) 120, 120′ of the anode current collector 100 vis-à-vis a corresponding lithium coupon (i.e. anode) 200 pressed onto or associated with such respective plate 120, 120′, for example. Relatedly, it is appreciated that the provided structure including the two sides of the anode current collector 100 and associated anode 200 may be mirror image of each other, i.e. such that ratios of such mirror image structure would be the same.

The current collector 100 may be a perforated metal, a stamped metal, an expanded metal, a grid, or a metallic fabric, for example. The material serving as a current collector can be chosen from the group comprising copper, stainless steel, nickel and/or titanium, for example. In accordance with one or more embodiments the material may be pure copper—as pure copper has a high electric conductivity. The alignment feature in the center of the current collector can assist proper anode to current collector alignment and anode current collector folding.

As illustratively shown in FIG. 4 and described above, for example, two holes, openings, or apertures 111 in the center of the tab 110 allow the current collector to sit, be supported and/or be seated on a fixture in a stationary disposition. In such disposition, the lithium coupons or anodes 200 can be pressed properly onto the current collector 100. Also, the two or more holes 111 afford a void of material that may allow easier folding of the current collector. Such arrangement may provide for (a) proper and/or needed geometry of the anode current collector 100 and other components within the cell, and (b) proper sandwiching of the cathode assembly 401 to fit into the cell case or housing 500. The lithium coupons 200 can be positioned on the anode current collector plates 120, 120′, and the anode current collector 100 can be folded to the shape of design, such as shown in FIG. 4. The aperture(s) 111 may serve as alignment feature during an assembling process. The apertures can help the anode current collector 100 be positioned on a support structure, and assists to allow consistent placement of a lithium coupon(s) 200 at the correct position on the anode current collector 100. In addition, the aperture(s) 111 can help fold the current collector 100 correctly.

In accordance with one or more embodiments of the disclosure, the apertures 111 can be fitted on or into a jig or assembly structure in the assembly process, so as to support the anode current collector 100. For example, the apertures 111 can be fitted over a pair of protuberances or studs (in or on an assembly structure) that match with the apertures 111. As a result, the anode current collector 100 can be accurately positioned on the assembly structure. The anodes 200, e.g. lithium coupons, can also be supported or positioned on the support structure on a respective, defined support that accurately positions the anodes 200 on the support structure. As a result of the accurate positioning of the lithium coupons 200 and the accurate positioning of the anode current collector 100 on the support structure, in the assembly process, each anode 200 can be accurately positioned on a respective plate of the plates 120, 120′.

Such a support structure can be positioned in the interior of the anode current collector 100 so as to support the anode current collector 100 and so as to be positioned to support the anodes 200. Such a support structure can also include bend plates that approach or sweep up on opposing sides of the supported anode current collector 100, so as to bend each plate 120, 120′ from a disposition shown in FIG. 5 to a disposition as shown in FIG. 4. Such an assembly process may also include heat applied, such as to the anode current collector 100.

As described above, the anode current collector 100 may include a negative current output terminal or connection 140 of the cell, which can be connected either to the current collector tabbing, or to the metallic lithium strip, or to both, for example.

In accordance with one or more embodiments, an electrode according to the disclosure can be used as an anode (negative electrode) of a primary lithium battery with a non-aqueous electrolyte. The electrolyte can be a salt (such as LiBF₄) dissolved in organic solvent or in a mixture of solvents.

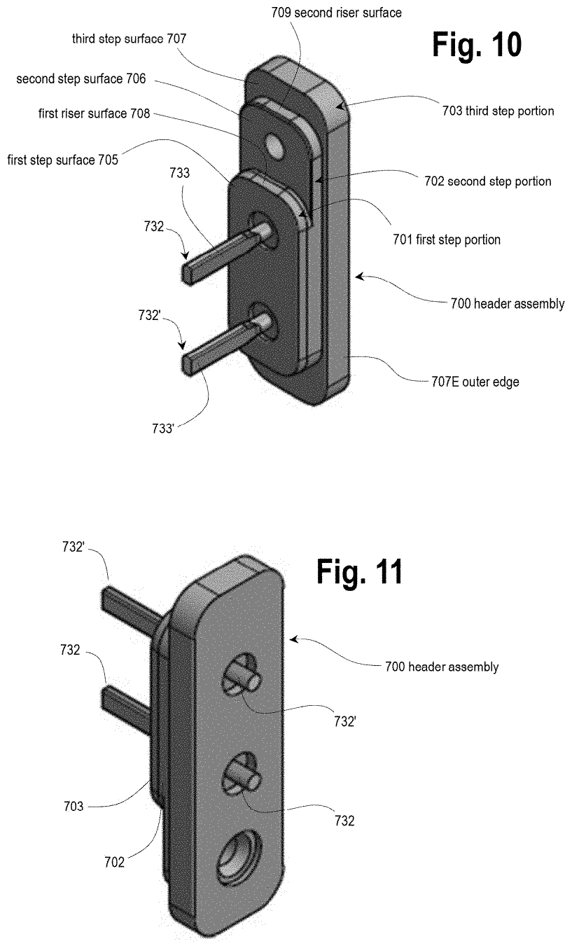

FIG. 7 is a perspective view of a header assembly 700 of a battery, showing Detail A of FIG. 2, in accordance with one or more embodiments. FIG. 8 is a cross-section view, along line 8-8 of FIG. 7, of a header assembly 700 the same as or similar to the header assembly of FIG. 1, in accordance with one or more embodiments. As shown in FIG. 7, the header assembly 700 includes a stepped header body 704. The stepped header body 704 may be dimensioned so as to be received into housing 500. The stepped header body 704 may be stepped (such as is shown FIG. 10) so as to accommodate components supported by or components in the stepped header body 704, as well as components positioned adjacent to the stepped header body 704.

The stepped header body 704, as shown in FIGS. 7 and 8, can include a fill assembly 710. The fill assembly 710 can include a fill aperture 711. The fill aperture 711 may be provided to add or remove electrolyte from the cell. The fill aperture 711 may be provided with a valve to prevent fluid flow there through. In accordance with one or more embodiments, the valve may be a ball valve, with the fill aperture dimensioned about a centerline so a receive a ball seal or ball 715 in a ball recess 714. A fill port cover 716 may be provided to cover the fill aperture 711 and valve of the aperture.

As shown in FIG. 7, the stepped header body 704 may also be provided with at least one pin aperture or passageway 720. The pin aperture 720 can be provided to accommodate a connection assembly 730, 730′. The connection assembly 730, for example, can provide an electrical path from an interior of the housing, in which the cell is located, through the connection assembly 730, to an exterior of the housing. In accordance with one or more embodiments, the connection assembly 730 can include a feed through pin 732, which can be a cathode feed through pin 732. The feed through pin 732 can provide a conductive path through the stepped header body 704. The feed through pin 732 may be supported by a substrate assembly 740, which can be a cathode substrate assembly 740. The substrate assembly 740 can include a lower substrate socket 741, a substrate sleeve 742, and an upper substrate socket 743. The substrate assembly 740 can provide a seal around and/or provide support to the feed through pin 732 in the pin aperture 720. The lower substrate socket 741 and the upper substrate socket 743 can be annular in shape, i.e. donut shaped, so as to encircle the feed through pin 732. The lower substrate socket 741 and the upper substrate socket 743 may be glass, resin or other suitable material. The lower substrate socket 741, upper substrate socket 743, and substrate sleeve 742 can be constructed of insulating material.

The feed through pin 732 may be connected to respective mating electrical connections. The feed through pin 732 may be connected to a pin extender 750 as shown in FIG. 7. The pin extender 750 may mate with the feed through pin 732 in telescopic manner as shown, or in other suitable manner. Relatedly, the stepped header body 704 may be provided with an annular recess 735 so as to receive at least a portion of the pin extender 750—so as to provide a more secure, stable and supported connection engagement. The annular recess 735 can be provided or defined by the pin aperture 720 and a top surface of the upper substrate socket 743.

The feed through pin 732 may be connected to the cathode positive connection or tab 440 so as to provide electrical connection between the cathode current collector 400 and the pin extender 750. The feed through pin 732 may be dimensioned or flattened at a flattened portion 733 on one or more sides as shown in FIG. 10 and FIG. 11 so as to effectively engage with the tab 440 or other connection and accordingly provide electrical connection between the cathode current collector 400 and the pin extender 750.

The header assembly 700 may also be provided with connection assembly 730′, i.e. an anode connection assembly 730′. The connection assembly 730′ can be similar or same in construct to the connection assembly 730. The connection assembly 730′ can provide an electrical path from an interior of the housing, in which the cell is located, through the connection assembly 730′, to an exterior of the housing. In accordance with one or more embodiments, the connection assembly 730′ can include a feed through pin 732′, i.e. an anode feed through pin. The feed through pin 732′ may be supported by a substrate assembly 740′. The substrate assembly 740′ can include a lower substrate socket 741′, a substrate sleeve 742′, and an upper substrate socket 743′. The substrate assembly 740′ can provide a seal around and/or provide support to the feed through pin 732′ in a pin aperture 720′. The lower substrate socket 741′ and the upper substrate socket 743′ can be annular in shape, i.e. donut shaped, so as to encircle the feed through pin 732′. The lower substrate socket 741′ and the upper substrate socket 743′ may be glass, resin or other suitable material. The lower substrate socket 741′, upper substrate socket 743′, and substrate sleeve 742′ can be constructed of insulating material.

The feed through pin 732′ may be connected to respective mating electrical connections. The feed through pin 732′ may be connected to a pin extender 750′ as shown in FIG. 7. In particular, the pin extender 750′ may mate with an upper end of the feed through pin 732′ in manner as shown, or in other suitable manner. Relatedly, the stepped header body 704 may be provided with an annular recess 735′ so as to receive at least a portion of the pin extender 750′—so as to provide a more secure and supported connection engagement. The annular recess 735′ can be provided or defined by the pin aperture 720′ and a top surface of the upper substrate socket 743′.

The feed through pin 732′ may be connected to the anode negative connection or tab 140 so as to provide electrical connection between the anode current collector 100 and the pin extender 750′, in accordance with one or more embodiments of the disclosure. The feed through pin 732′ may be dimensioned or flattened at a flattened portion 733′ on one or more sides as shown in FIG. 10 and FIG. 11 so as to effectively engage with the tab 140 or with other connection assembly, and accordingly provide electrical connection between the anode current collector 100, with tab 140, and the pin extender 750′.

Both the pin extender 750 and the pin extender 750′, as shown in FIG. 7 may be plated and/or otherwise enhanced in conductivity so as to provide good electrical connection to further electrical respective connections, i.e. that are placed or positioned, respectively, onto the pin extender 750 and the pin extender 750′, for example.

The connection assembly 730 and the connection assembly 730′ may be of the same or similar construct. The connection assembly 730 and the connection assembly 730′ may provide respective pass-through connections so as to provide electrical connection between the interior and the exterior of the cell.

As shown in FIGS. 10 and 11, for example, the header assembly 700 may include a first step portion 701, a second step portion 702, and a third step portion 703. The step portions 701, 702, 703 may be shaped and dimensioned so as to provide for the fill aperture 711, to provide desired stability and support to the feed through pins 732, 732′, and so as to accommodate or support other components as described herein.

Hereinafter, further details of the header assembly 700 will be described in accordance with the disclosed subject matter.

As described above, the electrochemical cell 10 of the disclosure can include a stepped header. The stepped header can include multiple step portions, i.e. stepped portions, having different thickness. The enhanced step design of the disclosed header can allow for enhanced or maximized internal cell volume. A first “step” of the cell can be designed and constructed around seal requirements, and specifically around glass-to-metal seal requirements. A second “step” of the cell can be designed and constructed around ball seal requirements. The electrochemical cell of the disclosure can, as a result, provide increased internal volume, the utilization of which allows the cell to attain electrolyte volume goals and void volume goals. Accordingly, the electrochemical cell of the disclosure can provide a high-energy-density electrochemical cell. The first step can be in the form of a first step portion 701. The second step can be in the form of a second step portion 702.

The second step portion 702 can possess sufficient thickness so that the contact area of ball or ball seal 715 to header is adequate to hold the ball and place. The ball can be as small as possible so that the thickness of the second step portion 702 can be smaller than the thickness of the first step portion 701. As a result, more cell internal volume can be yielded.

The first step portion 701 can be provided with sufficient thickness so that the glass, in a glass-to-metal seal can have sufficient thickness to form a hermetic seal. That is, such glass-to-metal seal can be provided in both the cathode connection assembly 730 and the anode connection assembly 730′ as described above. The step design of the disclosure allows the cell 10 to reach electrolyte and void volume goals, resulting in a high-energy-density electrochemical cell.

In accordance with the disclosure, the header assembly 700 can be provided in an opening 502 of the housing 500. The opening 502 can be defined by or provided by housing walls 501 of the housing 500. The housing walls 501 can define or provide an interior volume 503. The header assembly 700 can be provided to close the interior volume 503. The header assembly 700 can include a cathode connection assembly 730 as described above. The header assembly 700 can also include an anode connection assembly 730′

The header assembly 700 can include a stepped header body 704. The stepped header body 704 can include the first step portion 701. The first step portion 701 can be of a first thickness 701′. The first step portion 701 can include a first step surface 705. The stepped header body 704 can also include a second step portion 702. The second step portion 702 can be of a second thickness 702′. The second step portion 702 can include a second step surface 706. The first thickness 701′ can be thicker than the second thickness 702′. Also, a first riser surface 708 can extend between the first step surface 705 and the second step surface 706. The first thickness 701′ can be of a vertical dimension, as shown in FIG. 8 for example, so as to effectively accommodate the cathode connection assembly 730, with cathode seal 734, and the anode connection assembly 730′, with anode seal 734′. The second thickness 702′ can be of a vertical dimension, as shown in FIG. 8 for example, so as to effectively accommodate the fill assembly 710. Accordingly, the stepped arrangement of the stepped header body 704 provides needed depth of material in order to accommodate particular components in particular parts or portions of the stepped header body 704. However, the construction provides the ability to not exceed the depth of material that is needed. Accordingly, since the depth of material that is needed to accommodate the fill assembly 710 is less than the depth of material that is needed to accommodate the connection assemblies 730, 730′—the second thickness 702′ can be less than the first thickness 701′.

In accord with the disclosure, both the cathode pass-through connection 732 and the anode pass-through connection 732′ can pass-through the first step portion 701 of the stepped header body 704. As described above, the fill assembly 710 can be provided in the second step portion 702.

The stepped header body 704, of the header assembly 700, can also include a third step portion 703. The third step portion 703 can be constructed of a third thickness 703′. The third step portion 703 can include a third step surface 707. The second thickness 702′ can be thicker than the third thickness 703′. Accordingly, the second thickness 702′ can be between the first thickness 701′ and the third thickness 703′.

The stepped header body 704 can also include a second riser surface 709. The second riser surface 709 can extend between the second step surface 706 and the third step surface 707. As shown in FIG. 10, for example, the third step surface 707 can extend around an outer periphery or perimeter of the stepped header body 704. The third step surface 707 and the second riser surface 709 can engage with the housing wall 501 and/or interior components in the interior volume 503 of the electrochemical cell 10. As a result, the stepped header body 704 can be secured to the housing wall 501.

As described above, the third step surface 707 can extend around an outer periphery of the stepped header body 704. The stepped header body 704 can be rectangular in shape and include opposing sides and opposing ends of the stepped header body 704. Accordingly, the third step surface 707 can extend along the opposing sides of the stepped header body 704 and the opposing ends of the stepped header body 704. Relatedly, the stepped header body 704 can include an outer edge 707E. As shown in FIG. 3, the outer edge 707E can be seated with or mated with an inner surface of the housing wall 501. The outer edge 707E can be secured to the inner surface of the housing wall 501 utilizing welds or a welding ring 699.

In accordance with embodiments of the disclosed subject matter, the first step portion 701 (which accommodates the cathode connection assembly 730 and the anode connection assembly 730′) can have varying thickness. In one embodiment, the thickness of the first step portion 701, i.e. the first step, may be in a range of about 1.1 mm (millimeter) to about 1.9 mm. In another embodiment, the thickness of the first step portion 701 may be in a range of about 1.2 mm to about 1.8 mm. In yet another embodiment, the thickness of the first step portion 701 may be in a range of about 1.3 mm to about 1.7 mm. In one embodiment, the first step portion 701 of the header body 704 may have a thickness of about 1.5 mm.

In accordance with embodiments of the disclosed subject matter, the second step portion 702 (which accommodates the fill assembly 710) can have varying thickness. The thickness of the second step portion 702, i.e. the second step, may be in a range of about 0.7 mm to about 1.5 mm. In another embodiment, the thickness of the second step portion 702 may be in a range of about 0.8 mm to about 1.4 mm. In yet another embodiment, the thickness of the second step portion 702 may be in a range of about 0.9 mm to about 1.3 mm. In one embodiment, the second step portion 702 of the header may have a thickness of about 1.1 mm.

It is appreciated that the various components of embodiments of the disclosure may be made from any of a variety of materials including, for example, metal, copper, stainless steel, nickel, titanium, plastic, plastic resin, nylon, composite material, glass, and/or ceramic, for example, or any other material as may be desired. The material of the stepped header body 704, for example, can be constructed of titanium or stainless steel, in accordance with at least one embodiment of the invention.

A variety of production techniques may be used to make the apparatuses as described herein. For example, suitable casting and/or injection molding and other molding techniques, bending techniques, and other manufacturing techniques might be utilized. Also, the various components of the apparatuses may be integrally formed, as may be desired, in particular when using casting or molding construction techniques.

The various apparatuses and components of the apparatuses, as described herein, may be provided in various sizes, shapes, and/or dimensions, as desired.

It will be appreciated that features, elements and/or characteristics described with respect to one embodiment of the disclosure may be variously used with other embodiments of the disclosure as may be desired.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present.

It will be understood that when an element or layer is referred to as being “onto” another element or layer, the element or layer can be directly on another element or layer or intervening elements or layers. Examples include “attached onto”, secured onto”, and “provided onto”. In contrast, when an element is referred to as being “directly onto” another element or layer, there are no intervening elements or layers present. As used herein, “onto” and “on to” have been used interchangeably.

It will be understood that when an element or layer is referred to as being “attached to” another element or layer, the element or layer can be directly attached to the another element or layer or intervening elements or layers. In contrast, when an element is referred to as being “attached directly to” another element or layer, there are no intervening elements or layers present. It will be understood that such relationship also is to be understood with regard to: “secured to” versus “secured directly to”; “provided to” versus “provided directly to”; “connected to” versus “connected directly to” and similar language.

As used herein, the term “and/or” includes any and all combinations of one or more of the associated listed items.

It will be understood that, although the terms first, second, third, etc., may be used herein to describe various features, elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper”, “top”, “bottom”, “left”, “right” and the like, may be used herein for ease of description to describe the relationship of one element or feature to another element(s) or feature(s) as illustrated in the drawing figures. It will be understood that spatially relative terms are intended to encompass different orientations of structures in use or operation, in addition to the orientation depicted in the drawing figures. For example, if a device in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the disclosure. As used herein, the singular forms “a”, “an” and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to diagrams and/or cross-section illustrations, for example, that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of components illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment.

Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

Embodiments are also intended to include or otherwise cover methods of using and methods of manufacturing any or all of the elements disclosed above.

While the subject matter has been described in detail with reference to exemplary embodiments thereof, it will be apparent to one skilled in the art that various changes can be made, and equivalents employed, without departing from the scope of the disclosure.

All related art references and art references discussed herein are hereby incorporated by reference in their entirety. All documents referenced herein are hereby incorporated by reference in their entirety.

In conclusion, it will be understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. An electrochemical cell comprising:
a housing that includes a housing wall, the housing wall defining an opening and providing an interior volume;
a cathode in the housing;
a cathode connection, in the housing, that is associated with the cathode;
an anode in the housing;
an anode connection, in the housing, that is associated with the anode;
an electrolyte that is contained in the housing; and
a header assembly that is provided in the opening of the housing so as to close the interior volume, and the header assembly including:
a cathode connection assembly that includes a cathode pass-through connection that is attached to the cathode connection;
an anode connection assembly that includes an anode pass-through connection, which is attached to the anode connection; and
a stepped header body that includes (a) a first step portion having a first thickness and first step surface, (b) a second step portion having a second thickness and a second step surface, and the first thickness being thicker than the second thickness, and (c) a riser surface that extends between the first step surface and the second step surface.

2. The electrochemical cell of claim 1, wherein,
the cathode pass-through connection passes through the stepped header body; and
the anode pass-through connection passes through the stepped header body.

3. The electrochemical cell of claim 2, wherein the cathode pass-through connection passes through the first step portion and the anode pass-through connection passes through the first step portion.

4. The electrochemical cell of claim 1, the electrochemical cell further including a fill assembly, and the fill assembly provided in the second step portion.

5. The electrochemical cell of claim 4, the fill assembly including:
a passageway, and the passageway includes a ball recess, and
a ball that is disposed in the ball recess to provide a seal between the interior volume and exterior to the electrochemical cell.

6. The electrochemical cell of claim 3, wherein:
the cathode pass-through connection includes a cathode feed through pin that is conductive;
the cathode connection assembly further includes a cathode seal that surrounds the cathode feed through pin;
the anode pass-through connection includes an anode feed through pin that is conductive; and
the anode connection assembly further includes an anode seal that surrounds the anode feed through pin.

7. The electrochemical cell of claim 6, the cathode feed through pin is made of metal and the anode feed through pin is made of metal.

8. The electrochemical cell of claim 1, the stepped header body is rectangular in shape.

9. The electrochemical cell of claim 6, wherein:
the cathode seal includes an upper substrate socket, a lower substrate socket, and a substrate sleeve, and the substrate sleeve provided between the upper substrate socket and the lower substrate socket; and
the anode seal includes a further upper substrate socket, a further lower substrate socket, and a further substrate sleeve, and the further substrate sleeve provided between the further upper substrate socket and the further lower substrate socket.

10. The electrochemical cell of claim 9, the upper substrate socket and the lower substrate socket are constructed of glass; and
the further upper substrate socket and the further lower substrate socket are constructed of glass.

11. The electrochemical cell of claim 1, wherein the cathode pass-through connection passes through the first step portion and the anode pass-through connection passes through the first step portion; and
the cathode pass-through connection includes a cathode feed through pin that is conductive;
the cathode connection assembly further includes a cathode seal that surrounds the cathode feed through pin;
the anode pass-through connection includes an anode feed through pin that is conductive; and
the anode connection assembly further includes an anode seal that surrounds the anode feed through pin.

12. The electrochemical cell of claim 1, wherein the electrochemical cell further including a fill assembly, and the fill assembly provided in the second step portion, and the fill assembly including:
a passageway, and the passageway includes a ball recess, and
a ball that is disposed in the ball recess to provide a seal between the interior volume and exterior to the electrochemical cell.

13. The electrochemical cell of claim 1, the electrochemical cell further includes a third step portion having a third thickness and third step surface, and the second thickness being thicker than the third thickness.

14. The electrochemical cell of claim 13, the electrochemical cell including a second riser surface, and the second riser surface extends between the second step surface and the third step surface.

15. The electrochemical cell of claim 14, wherein both the third step surface and the second riser surface engage with the housing wall and/or interior components in the interior volume to secure the stepped header body to the housing.

16. The electrochemical cell of claim 15, wherein the stepped header body includes opposing sides and opposing ends; and
the third step surface extends around an outer periphery of the stepped header body including the sides and ends of the stepped header body.
